(19) United States
(12) Patent Application Publication
(10) Pub. No.: US 2026/0246640 A1
(43) Pub. Date: Aug. 20, 2026

(54) Probabilistic Admission Control and Deterministic Mutation Governance System

(71) Applicant: Andrew Louie Montilla Francisco, Saint Augustine, FL (US)

(72) Inventor: Andrew Louie Montilla Francisco, Saint Augustine, FL (US)

(21) Appl. No.: 19/544,983

(22) Filed: Feb. 19, 2026

Related U.S. Application Data
(60) Provisional application No. 63/760,135, filed on Feb. 19, 2025.
(60) Provisional application No. 63/760,373, filed on Feb. 19, 2025.

(51) Int. Cl. H04L 9/32; H04L 9/00

(52) U.S. Cl. CPC H04L 9/3213; H04L 9/3247; H04L 9/50

(57) ABSTRACT

A probabilistic admission control system governs the admission of probabilistic inference outputs into a deterministic processor-enforced mutation authority boundary. A processor-computed uncertainty metric is compared to a predefined threshold. Upon satisfaction of the threshold, a cryptographically verifiable DecisionToken is generated. Mutation of a governed memory region is inhibited at the mutation authority boundary unless the DecisionToken is validated. Escalation fallback prevents mutation under insufficient confidence or calibration degradation. Replay suppression blocks application-layer invocation of live inference during reconstruction. Admission events are recorded in a tamper-evident structure to support auditability and deterministic state-transition control.

### CROSS-REFERENCE TO RELATED APPLICATIONS

This application claims priority to U.S. Provisional Patent Application No. 63/760,373, filed Feb. 19, 2025, and U.S. Provisional Patent Application No. 63/760,135, filed Feb. 19, 2025, the disclosures of which are incorporated herein by reference in their entirety.

### FIELD OF THE INVENTION

The present invention relates to probabilistic inference systems, deterministic state-transition control, cryptographically verifiable authorization mechanisms, and governance architectures for distributed computing environments.

More particularly, the invention relates to systems and methods for preventing mutation of governed state by probabilistic outputs unless predefined probabilistic sufficiency criteria are satisfied, authorization artifacts are validated, and mutation-authority boundary controls are enforced.

### BACKGROUND OF THE INVENTION

Artificial intelligence and machine learning systems generate probabilistic outputs that are frequently used within automated workflows, regulated computational environments, and distributed service architectures.

Such systems inherently exhibit uncertainty due to distribution shift, model drift, approximation error, dataset imbalance, calibration degradation, stochastic inference behavior, and nondeterministic retrieval mechanisms.

Conventional computing systems allow probabilistic outputs to directly mutate authoritative system state without enforcing deterministic mutation boundaries, explicit probabilistic sufficiency thresholds, cryptographically verifiable authorization artifacts, escalation safeguards, replay suppression mechanisms, or tamper-evident audit continuity.

As a result, probabilistic uncertainty may propagate into governed memory regions representing authoritative system state, thereby compromising deterministic state-transition integrity, auditability, and replay verifiability.

There exists a need for a probabilistic admission control system that enforces deterministic mutation-authority boundary control such that probabilistic outputs cannot directly mutate governed state absent validated authorization and deterministic substrate-level gating.

### SUMMARY OF THE INVENTION

The present invention provides a probabilistic admission control and deterministic mutation governance system configured to control mutation of a governed memory region using processor-enforced mutation-authority boundary mechanisms.

In one embodiment, a multimodal inference engine executed by one or more processors generates probabilistic outputs based on multimodal inputs.

An uncertainty evaluation module computes a probabilistic sufficiency metric using processor-executed arithmetic operations.

A comparison module determines whether the probabilistic sufficiency metric satisfies a predefined threshold.

Upon satisfaction of the predefined threshold, an authorization artifact generator produces a cryptographically verifiable DecisionToken.

A mutation-authority boundary enforces a fail-closed default state in which write-permission to a governed memory region is inhibited unless the DecisionToken is validated.

Mutation eligibility is conditionally enabled only upon successful validation of required authorization artifacts at the mutation-authority boundary.

Escalation-only mode is activated when sufficiency criteria are not met or when calibration degradation is detected.

During replay mode, application-layer invocation of live inference and nondeterministic retrieval mechanisms is suppressed, and reconstruction occurs exclusively from schema-defined stored artifacts.

Admission decisions may be recorded in a tamper-evident structure including hash chaining or Merkle tree constructions.

The invention improves deterministic execution reliability by preventing nondeterministic probabilistic outputs from directly mutating authoritative system state absent processor-enforced deterministic mutation boundary validation. The mutation-authority boundary is implemented using processor-executed control over memory write-permissions at a computing substrate level independent of application-layer decision logic.

### BRIEF DESCRIPTION OF THE DRAWINGS

FIG. 10 is a platform-level architecture diagram illustrating probabilistic inference and mutation-boundary governance.

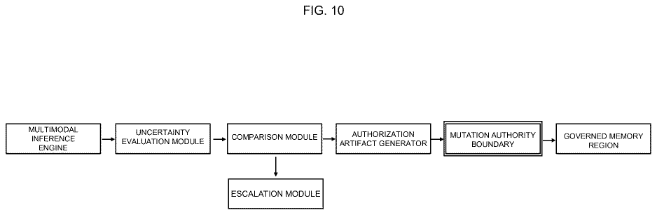

FIG. 11 is a microservices topology diagram illustrating distributed execution of probabilistic admission control.

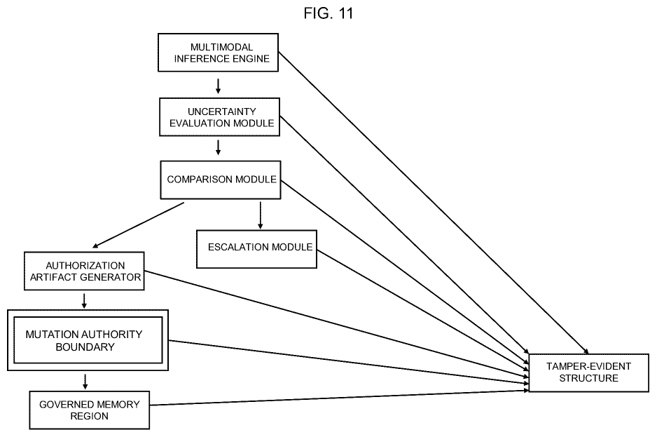

FIG. 12 is a multimodal inference engine diagram illustrating probabilistic output generation.

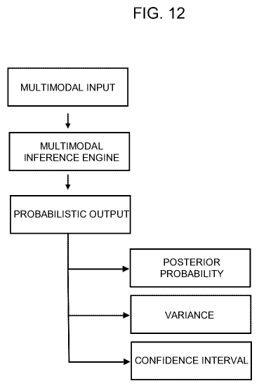

FIG. 13 is a governance stack diagram illustrating threshold comparison, token issuance, escalation fallback, and audit logging.

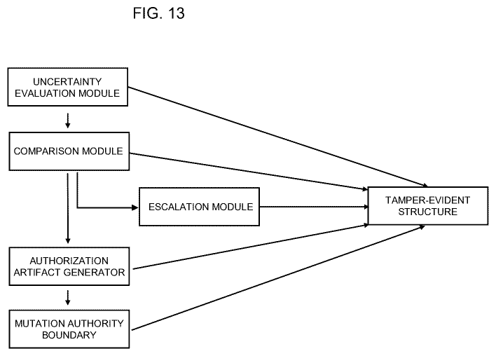

FIG. 14 is a probabilistic sufficiency evaluation pipeline illustrating computation of uncertainty metrics.

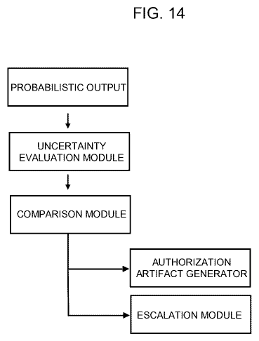

FIG. 15 is a fairness monitoring and explainability integration diagram.

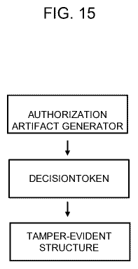

FIG. 16 is a data topology diagram illustrating storage of probabilistic outputs, tokens, and audit logs.

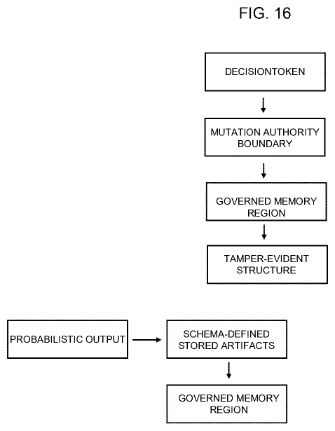

FIG. 17 is an end-to-end system flow diagram illustrating capture, processing, gating, logging, and escalation.

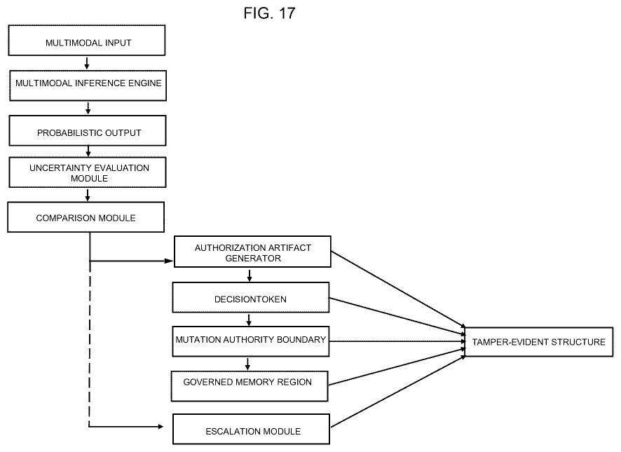

FIG. 18 is a calibration sentinel diagram illustrating empirical coverage monitoring and conditional activation of escalation-only mode upon degradation.

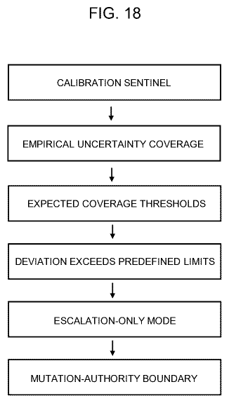

### DETAILED DESCRIPTION OF THE INVENTION

### Definitions

Probabilistic Output: An output generated by an inference engine representing likelihoods, classifications, similarity scores, regression outputs, or other probabilistic measures.

Probabilistic Sufficiency Metric: A processor-computed metric indicating whether a probabilistic output satisfies predefined acceptance criteria.

DecisionToken: A cryptographically verifiable artifact binding a probabilistic output to contextual identifiers and validation metadata, including policy identifiers, model identifiers, snapshot identifiers, schema hashes, expiration metadata, and digital signatures.

Mutation Authority Boundary: A processor-enforced deterministic execution boundary at which mutation of a governed memory region is permitted only upon validation of required authorization artifacts.

Governed Memory Region: A memory region representing an authoritative system state subject to mutation-authority boundary control.

Escalation Mode: A fail-safe state in which mutation is denied or deferred pending additional validation.

Replay Mode: An execution mode in which live inference invocation and nondeterministic retrieval mechanisms are suppressed, and reconstruction occurs exclusively from schema-defined stored artifacts.

### Multimodal Inference Engine

The system receives multimodal inputs including textual inputs, media content, metadata, telemetry-derived signals, or combinations thereof.

The inference engine computes probabilistic outputs using processor-executed machine learning models.

No embodiment requires interception of internal model logits, direct modification of model weights, or specialized hardware.

### Probabilistic Sufficiency Evaluation

The uncertainty evaluation module computes a probabilistic sufficiency metric using processor-executed arithmetic operations.

Non-limiting embodiments include posterior variance estimation, Bayesian posterior probability calculation, confidence interval evaluation, conformal prediction coverage determination, ensemble variance computation, Monte Carlo sampling, calibrated probability normalization, and drift detection metrics.

The probabilistic sufficiency metric produces a threshold-based determination and does not require ranked ordering of candidate entities.

### Authorization Artifact Generation

Upon satisfaction of the predefined threshold, the system generates a DecisionToken comprising policy identifiers, model identifiers, snapshot identifiers, output hashes, schema hashes, expiration metadata, and digital signatures.

The DecisionToken is generated using processor-executed cryptographic operations.

The DecisionToken does not itself mutate state.

### Mutation Boundary Enforcement

Mutation of the governed memory region is inhibited by default in a fail-closed condition.

Write-permission to the governed memory region is conditionally enabled only upon successful validation of the DecisionToken at the processor-enforced mutation-authority boundary.

The probabilistic sufficiency determination does not itself cause state mutation. Rather, the sufficiency metric governs whether processor-enforced write-permission may be enabled at the mutation-authority boundary.

The mutation-authority boundary operates independently of application-layer business logic and enforces deterministic state-transition control at the memory-region level.

Mutation-boundary enforcement may be implemented within managed runtime isolation boundaries, transactional commit systems, versioned state commit systems, or processor-mediated execution contexts.

### Escalation Fallback

If the probabilistic sufficiency metric fails to satisfy the predefined threshold, mutation is denied, deferred, or escalated for human review.

Escalation-only mode overrides threshold satisfaction when calibration degradation is detected.

### Replay Suppression

During replay mode, application-layer invocation of live inference is suppressed.

Execution paths associated with nondeterministic retrieval are gated.

Reconstruction occurs exclusively from schema-defined stored artifacts.

### Audit Logging and Tamper Evidence

Admission decisions may be recorded in a tamper-evident structure.

Tamper-evident mechanisms may include hash chaining, Merkle tree construction, immutable checkpoint storage, or equivalent cryptographic continuity mechanisms.

### Calibration Sentinel

A monitoring subsystem evaluates empirical uncertainty coverage over time.

Observed coverage is compared to expected coverage thresholds.

When deviation exceeds predefined limits, escalation-only mode is activated.

The calibration sentinel does not modify model weights but prevents mutation eligibility at the mutation-authority boundary upon detection of degradation.

### Deployment Embodiments

Non-limiting deployment embodiments include managed runtime execution, cluster-based microservices, containerized execution environments, and confidential compute environments.

1. A probabilistic admission control system comprising:
one or more processors;
a non-transitory memory storing executable instructions; and
a governed memory region stored in the non-transitory memory and representing authoritative system state;
wherein execution of the executable instructions by the one or more processors causes the system to:
generate, using a multimodal inference engine, a probabilistic output based on multimodal input;
compute, using processor-executed arithmetic operations, a probabilistic sufficiency metric associated with the probabilistic output;
compare the probabilistic sufficiency metric to a predefined threshold;
generate, upon satisfaction of the predefined threshold, a cryptographically verifiable DecisionToken binding the probabilistic output to contextual identifiers and validation metadata;
enforce a processor-mediated mutation-authority boundary maintaining the governed memory region in a default write-inhibited state; and
conditionally enable write-permission to the governed memory region only upon successful validation of the DecisionToken at the mutation-authority boundary, thereby preventing mutation of the governed memory region absent validated authorization.

2. The system of claim 1, wherein the probabilistic sufficiency metric comprises posterior variance.

3. The system of claim 1, wherein the probabilistic sufficiency metric comprises conformal prediction coverage.

4. The system of claim 1, wherein the probabilistic sufficiency metric comprises ensemble variance.

5. The system of claim 1, wherein the probabilistic sufficiency metric comprises Monte Carlo sampling-derived uncertainty.

6. The system of claim 1, wherein the DecisionToken comprises:
a policy identifier;
a model identifier;
a model snapshot identifier;
an output hash;
a schema hash;
an expiration value; and
a cryptographic signature.

7. The system of claim 6, wherein the cryptographic signature is generated using asymmetric cryptography.

8. The system of claim 1, wherein the mutation-authority boundary operates independently of application-layer business logic.

9. The system of claim 1, wherein the mutation-authority boundary is enforced at a managed runtime isolation boundary.

10. The system of claim 1, wherein the mutation-authority boundary is enforced at a transactional commit boundary.

11. The system of claim 1, further comprising an escalation module configured to deny or defer mutation when the probabilistic sufficiency metric fails to satisfy the predefined threshold.

12. The system of claim 11, further comprising a calibration sentinel configured to monitor empirical coverage of probabilistic outputs and activate an escalation-only mode when deviation from expected coverage exceeds a predefined limit.

13. The system of claim 12, wherein activation of escalation-only mode prevents mutation eligibility at the mutation-authority boundary.

14. The system of claim 1, further comprising a replay suppression module configured to:
suppress application-layer invocation of live inference during replay mode; and
reconstruct system state exclusively from schema-defined stored artifacts.

15. The system of claim 14, wherein replay mode further gates execution paths associated with nondeterministic retrieval mechanisms.

16. The system of claim 1, further comprising a tamper-evident audit structure recording admission decisions.

17. The system of claim 16, wherein the tamper-evident audit structure comprises hash chaining.

18. The system of claim 16, wherein the tamper-evident audit structure comprises a Merkle tree.

19. The system of claim 1, wherein mutation of the governed memory region remains fail-closed absent validated authorization artifacts.

20. The system of claim 1, wherein export or external transmission of state is treated as a gated state-transition event requiring validation at the mutation-authority boundary.

21. A method of governing probabilistic inference prior to mutation of authoritative system state, comprising:
receiving multimodal input;
generating a probabilistic output using a processor-executed inference engine;
computing a probabilistic sufficiency metric associated with the probabilistic output;
comparing the probabilistic sufficiency metric to a predefined threshold;
generating, upon satisfaction of the predefined threshold, a cryptographically verifiable DecisionToken;
maintaining a governed memory region in a default write-inhibited state via processor-enforced mutation-authority boundary control;
enabling write-permission to the governed memory region only upon successful validation of the DecisionToken; and
denying or deferring mutation when the probabilistic sufficiency metric fails to satisfy the predefined threshold.

22. The method of claim 21, further comprising activating an escalation-only mode upon detection of calibration degradation.

23. The method of claim 21, further comprising suppressing application-layer invocation of live inference during replay reconstruction.

24. The method of claim 21, further comprising recording admission decisions in a tamper-evident structure.

25. A non-transitory computer-readable medium storing instructions that, when executed by one or more processors, cause the one or more processors to perform the method of claim 21.
